(19) United States
(12) Patent Application Publication
(10) Pub. No.: US 2025/0162654 A1
(43) Pub. Date: May 22, 2025

(54) VEHICLE FRONT SECTION STRUCTURE

(71) Applicant: TOYOTA JIDOSHA KABUSHIKI KAISHA, Toyota-shi Aichi-ken (JP)

(72) Inventor: Masanori YOSHIMOTO, Okazaki-shi Aichi-ken (JP)

(73) Assignee: TOYOTA JIDOSHA KABUSHIKI KAISHA, Toyota-shi Aichi-ken (JP)

(21) Appl. No.: 18/944,981

(22) Filed: Nov. 12, 2024

(30) Foreign Application Priority Data
Nov. 16, 2023 (JP) 2023-195382

(51) Int. Cl. B62D 25/08

(52) U.S. Cl. CPC B62D 25/085

(57) ABSTRACT

A vehicle front section structure includes: a left-right pair of front pillars; a left-right pair of front side members extending along a vehicle front-rear direction and disposed at a vehicle front side of the left-right pair of front pillars; a left-right pair of suspension towers respectively projecting toward an upper side with respect to the front side members; a connection member connecting the left-right pair of suspension towers or connecting the left-right pair of front side members, the connection member including a main body extending in the vehicle width direction, and an inclined connection portion that extends toward a rear side and toward a vehicle width direction outer side from at least one end portion of a first side end portion or a second side end portion, in the vehicle width direction, of the main body; and a brace connecting the inclined connection portion to a front pillar.

### CROSS-REFERENCE TO RELATED APPLICATION

This application claims priority under 35 USC 119 from Japanese Patent Application No. 2023-195382 filed Nov. 16, 2023, the disclosure of which is incorporated by reference herein in its entirety.

### BACKGROUND

### Technical Field

The present disclosure relates to a vehicle front section structure.

### Related Art

Japanese Patent Application Laid-Open (JP-A) No. 2007-230490 discloses a vehicle body front section structure implemented to transmit collision load acting on front side frames to a vehicle body upper section.

In the vehicle body front section structure described in this publication, an upper portion of suspension tower portions (suspension towers) and the front side frames further toward a vehicle front side than the suspension tower portions, are coupled together by a left-right pair of first members. The first members are arranged spaced apart from each other by a distance that becomes smaller toward the vehicle front side in plan view. Furthermore, the upper portions of the suspension tower portions are joined together by a suspension tower bar extending in the vehicle width direction. This thereby enables the front side frames to be suppressed from bending upward, enabling energy absorption to be realized by axial compression of the front side frames.

### SUMMARY

However, when a vehicle is involved in an offset collision with a collision object, such as a small overlap head on collision or the like, it would be desirable for the vehicle to obtain a reaction force causing displacement of the vehicle toward the opposite side to the collision object, however there is room for improvement regarding this point with the configuration described in JP-A No. 2007-230490.

In consideration of the above circumstances, the present disclosure provides a vehicle front section structure capable of obtaining a reaction force to displace a vehicle toward the opposite side to a collision object when the vehicle is involved in an offset collision with a collision object, such as a small overlap head on collision or the like.

A vehicle front section structure of a first aspect includes a left-right pair of front pillars, the front pillars respectively forming parts of front door openings that are respectively formed at a left and a right side in a vehicle width direction, a left-right pair of front side members extending along a vehicle front-rear direction and disposed spaced apart from each other in the vehicle width direction at a vehicle front side with respect to the front pillars, a left-right pair of suspension towers respectively formed with profiles that project toward an upper side with respect to the left-right pair of front side members, a connection member connecting the left-right pair of suspension towers or connecting the left-right pair of front side members, the connection member including a main body extending in the vehicle width direction and an inclined connection portion that extends toward a rear side and toward a vehicle width direction outer side from at least one end portion of a first side end portion or a second side end portion, in the vehicle width direction, of the main body, and a brace connecting the inclined connection portion to a front pillar on an inclined connection portion side.

In the vehicle front section structure of the first aspect, the left-right pair of front side members are disposed at the vehicle front side of the left-right pair of front pillars. Moreover, the left-right pair of suspension towers are respectively joined to the left-right pair of front side members. Furthermore, the left-right pair of suspension towers are connected in the vehicle width direction through the connection member, or the left-right pair of front side members are connected in the vehicle width direction through the connection member. The connection member includes the main body extending in the vehicle width direction. The connection member also includes the inclined connection portion that extends toward the rear side and toward the vehicle width direction outer side from at least one end portion of the first side end portion or the second side end portion, in the vehicle width direction, of the main body. Furthermore, the inclined connection portion and the front pillar on the inclined connection portion side are connected through the brace. This means that when the first side, in the vehicle width direction, of the vehicle front section applied with the vehicle front section structure of the first aspect is involved in an offset collision with a collision object, such as a small overlap head on collision or the like, collision load therefrom is transmitted to the front pillar at the second side in the vehicle width direction through the main body and the inclined connection portion, and through the brace. This configuration enables collision load that has been input to the vehicle width direction first side of the vehicle front section to be transmitted at an angle toward the front pillar on the vehicle width direction second side of the vehicle. This thereby enables a larger reaction force to displace the vehicle toward the opposite side to the collision object (reaction force from the collision object) to be obtained than in configurations in which the inclined connection portion does not extend in the direction described above and the brace is not provided.

A vehicle front section structure of a second aspect includes a left-right pair of front pillars, the front pillars respectively forming parts of front door openings that are respectively formed at a left side and a right side in a vehicle width direction, a left-right pair of front side members extending along a vehicle front-rear direction and disposed spaced apart from each other in the vehicle width direction at a vehicle front side with respect to the left-right pair front pillars, a left-right pair of suspension towers respectively formed with profiles that project toward an upper side with respect to the front side members, a connection member extending in the vehicle width direction and connecting the left-right pair of suspension towers or connecting the left-right pair of front side members, and at least one brace of a brace that connects an inner side location, in the vehicle width direction, of a suspension tower on a first side in the vehicle width direction to a front pillar on the first side in the vehicle width direction or a brace that connects an inner side location, in the vehicle width direction, of a suspension tower on a second side in the vehicle width direction to a front pillar on the second side in the vehicle width direction.

In the vehicle front section structure of the second aspect, the left-right pair of front side members are provided further toward the vehicle front side than the left-right pair of front pillars. Moreover, the left-right pair of suspension towers are respectively joined to the left-right pair of front side members. Furthermore, the left-right pair of suspension towers are connected in the vehicle width direction through the connection member, or the left-right pair of front side members are connected in the vehicle width direction through the connection member. At least one of the braces is provided, The braces includes a brace that connects the inner side location, in the vehicle width direction, of the suspension tower on the vehicle width direction first side to the front pillar on the vehicle width direction first side, or a brace that connects the inner side location, in the vehicle width direction, of the suspension tower on the vehicle width direction second side to the front pillar on the vehicle width direction second side. This means that the vehicle front section is applied with the vehicle front section structure in which the brace connects the inner side location, in the vehicle width direction, of the suspension tower on the vehicle width direction second side to the front pillar on the vehicle width direction second side, and when the first side, in the vehicle width direction, of the vehicle front section is involved in an offset collision with a collision object, such as a small overlap head on collision or the like, the collision load from the collision object is transmitted to the front pillar on the second side in the vehicle width direction through the connection member and the brace. This configuration enables a collision load input to the vehicle width direction first side of the vehicle front section to be transmitted at an angle toward the front pillar on the vehicle width direction second side of the vehicle. This thereby enables a larger reaction force to displace a vehicle toward the opposite side to the collision object (reaction force from the collision object) to be obtained than in configurations in which a brace is not provided to connect the vehicle width direction inner side location of the suspension tower to the front pillar on the vehicle width direction second side. When the vehicle front section is applied with the vehicle front section structure in which the brace connects the vehicle width direction inner side location of the suspension tower on the vehicle width direction first side to the front pillar on the vehicle width direction first side, and the second side of the vehicle front section is involved in an offset collision with a collision object, such as a small overlap head on collision or the like, the collision load from the collision object is transmitted to the front pillar on the vehicle width direction first side through the connection member and the brace. In this configuration, collision load input to the vehicle width direction second side of the vehicle front section can be transmitted at an angle toward the front pillar on the vehicle width direction first side of the vehicle. This thereby enables a larger reaction force to displace a vehicle toward the opposite side to the collision object (reaction force from the collision object) to be obtained than in configurations in which a brace is not provided to connect the vehicle width direction inner side location of the suspension tower on the vehicle width direction first side to the vehicle width direction first side front pillar.

A vehicle front section structure of a third aspect is the vehicle front section structure of the first aspect, wherein the brace is provided so as to be disposed along a direction of extension of the inclined connection portion.

In the vehicle front section structure of the third aspect, the brace is provided so as to be disposed along the direction of extension of the inclined connection portion. In this configuration, load transmitted to the inclined connection portion can be transmitted more effectively to the brace than configurations in which the brace is provided along a direction different to the direction described above.

A vehicle front section structure of a fourth aspect is the vehicle front section structure of the first aspect, wherein the main body is curved so as to be a convex shape toward the vehicle front side in vehicle plan view.

In the vehicle front section structure of the fourth aspect the main body is curved so as to be a convex shape toward the vehicle front side in vehicle plan view. In this configuration when a collision load accompanying an offset collision is transmitted to the main body, a force to cause axial compression is generated on the main body in addition to a force attempting to bend the main body. This thereby enables deformation of the connection member to be suppressed compared to configurations in which a force to cause axial compression of the main body is not generated when such a collision load is transmitted to the main body (as an example, configurations in which the main body extends in a straight line in the vehicle width direction).

A vehicle front section structure of a fifth aspect is the vehicle front section structure of the first aspect, wherein the connection member includes a front connection portion that extends from an end portion on a side of the main body where the inclined connection portion is provided toward a vehicle front side and toward a vehicle width direction outer side, and the front connection portion and the inclined connection portion are fixed to the suspension tower.

In the vehicle front section structure of the fifth aspect, the front connection portion and the inclined connection portion are fixed to the suspension tower. This thereby enables the portion of the suspension tower where the front connection portion and the inclined connection portion have been affixed to be reinforced.

A vehicle front section structure of a sixth aspect is the vehicle front section structure of the fifth aspect, wherein a coilover fixing portion to which a coilover is to be fixed is provided at the suspension tower, the front connection portion is fixed to a location on the suspension tower further toward the vehicle front side than the coilover fixing portion, and the inclined connection portion is fixed to a location on the suspension tower further toward a vehicle rear side than the coilover fixing portion.

In the vehicle front section structure of the sixth aspect, the front connection portion and the inclined connection portion are fixed to the suspension tower further to the vehicle front side and further to the vehicle rear side than the coilover fixing portion. This thereby enables the suspension tower to be reinforced in the vicinity of the coilover fixing portion.

A vehicle front section structure of a seventh aspect is the vehicle front section structure of the first aspect or the third aspect, wherein the left-right pair of front side members and the left-right pair of suspension towers are formed as a single body.

In the vehicle front section structure of the seventh aspect, the left-right pair of front side members and the left-right pair of suspension towers are formed as a single body. This configuration enables a number of components of the vehicle front section to be reduced compared to configurations in which each of the members is configured by a separate member.

The vehicle front section structure according to the present disclosure exhibits the effect of, when a vehicle is involved in an offset collision with a collision object, such as a small overlap head on collision or the like, being able to obtain a reaction force that displaces the vehicle toward the opposite side to the collision object.

### BRIEF DESCRIPTION OF THE DRAWINGS

Exemplary embodiments of the present disclosure will be described in detail based on the following figures, wherein:

FIG. 1 is a perspective view of a vehicle front section applied with a vehicle front section structure of a first exemplary embodiment, as viewed diagonally from a front side and above;

FIG. 2 is a plan view of a vehicle front section applied with a vehicle front section structure of the first exemplary embodiment, as viewed from above;

FIG. 3 is a perspective view illustrating a vehicle front section applied with a vehicle front section structure of a second exemplary embodiment;

FIG. 4 is a plan view illustrating a vehicle front section applied with a vehicle front section structure of the second exemplary embodiment;

FIG. 5 is a front view illustrating a vehicle front section applied with a vehicle front section structure of the second exemplary embodiment;

FIG. 6 is a perspective view illustrating a vehicle front section applied with a vehicle front section structure of a third exemplary embodiment;

FIG. 7 is a plan view illustrating a vehicle front section applied with a vehicle front section structure of the third exemplary embodiment;

FIG. 8 is a front view illustrating a vehicle front section applied with a vehicle front section structure of the third exemplary embodiment;

FIG. 9 is a perspective view illustrating a vehicle front section applied with a vehicle front section structure of a fourth exemplary embodiment;

FIG. 10 is a plan view illustrating a vehicle front section applied with a vehicle front section structure of the fourth exemplary embodiment; and

FIG. 11 is a front view illustrating a vehicle front section applied with a vehicle front section structure of the fourth exemplary embodiment.

### DETAILED DESCRIPTION

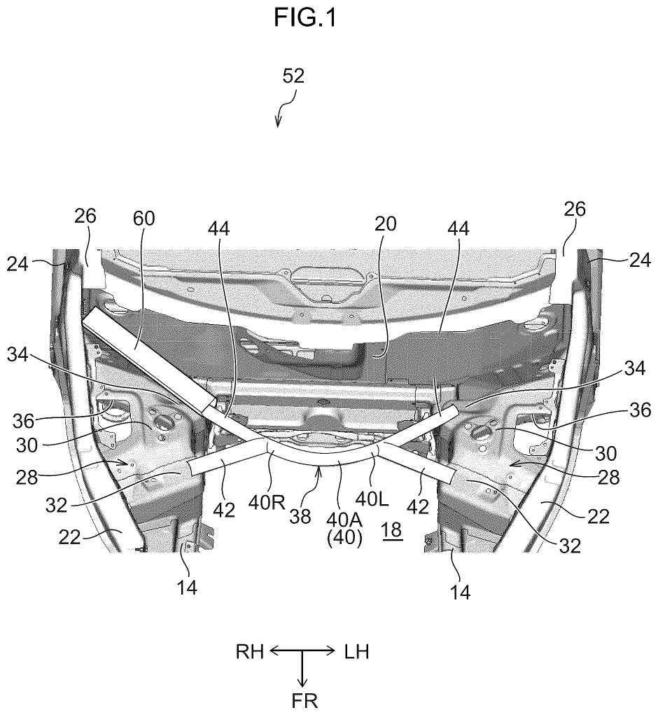

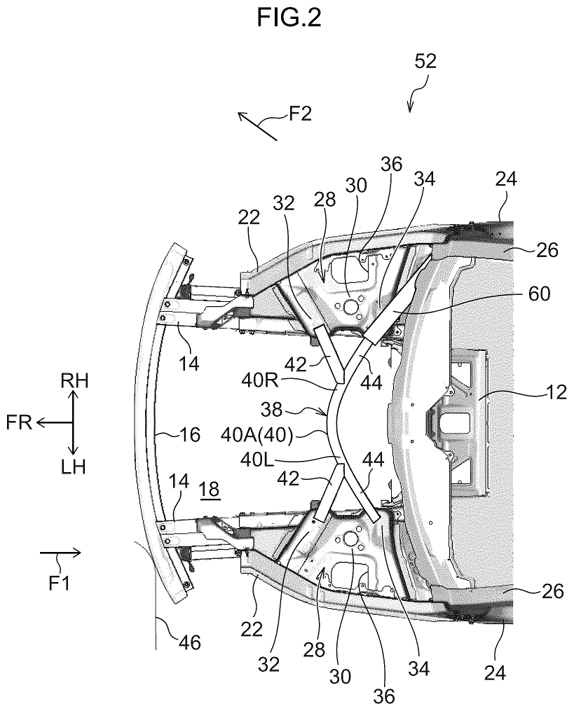

Description follows regarding the vehicle front section 52 applied with a vehicle front section structure according to the exemplary embodiment of the present disclosure, with reference to FIG. 1 and FIG. 2. Note that as appropriate in the drawings, an arrow FR indicates a vehicle front-rear direction front side, an arrow UP indicates a vehicle height direction upper side, an arrow RH indicates a vehicle width direction right side, and an arrow LH indicates a vehicle width direction left side. Moreover, unless explicitly stated otherwise, references in the description simply to front and rear, left and right, and up and down directions indicate front and rear in the vehicle front-rear direction, left and right in the vehicle left-right direction (vehicle width direction), and up and down in the vehicle height direction.

As illustrated in FIG. 1 and FIG. 2, in the vehicle front section 52, a left-right pair of front side members 14 that extend in a front-rear direction are disposed spaced apart from each other in the vehicle width direction at a front side of a cabin 12. Each of the front side members 14 is formed with a rectangular shaped cross-section sectioned along the height and left-right directions. A bumper reinforcement 16 is also fixed to front end portions of each of the front side members 14. Note that a non-illustrated power unit and the like are fixed to the front side members 14. Moreover, in the vehicle front section 52 a space (power unit room 18) where the power unit and the like is disposed and the cabin 12 are partitioned by a dash panel 20.

In the vehicle front section 52 a left-right pair of apron upper members 22 is provided extending in the front-rear direction at an upper side and vehicle width direction outer side with respect to the left-right pair of front side members 14. Rear end portions of the apron upper members 22 are respectively joined to a left-right pair of front pillars 26 configuring part of respective vehicle front door openings 24. Note that each of the front pillars 26 is configured including a front pillar upper member disposed at an upper side with respect to the apron upper members 22, and a front pillar lower member disposed further to the lower side than the front pillar upper member.

A left-right pair of suspension towers 28 is provided at the vehicle front section 52. The suspension towers 28 cover a left-right pair of front wheels from the respective upper side thereof. The suspension towers 28 are respectively formed with profiles that project toward the upper side with respect to the front side members 14. Furthermore, lower end portions of the suspension towers 28 are respectively joined to the front side members 14. Furthermore, upper end portions and vehicle width direction outer side end portions of the suspension towers 28 are respectively joined to the apron upper members 22. Note that the parts corresponding to the front side members such as the left-right pair of front side members 14, the left-right pair of suspension towers 28, the left-right pair of apron upper members 22, and the like may be configured by being formed as a single body, by casting or the like.

A coilover fixing portion 30 to which an upper end portion of a non-illustrated coilover is fixed is provided at an intermediate portion, in the front-rear direction, and at an inner side location, in the vehicle width direction, of an upper portion of each of the suspension towers 28. A first fixing portion 32 is formed at an inner side location, in the vehicle width direction, and at a front side with respect to the coilover fixing portion 30 of the upper portion of the suspension towers 28. The first fixing portion 32 is offset to a lower side with respect to the coilover fixing portion 30. Moreover, a second fixing portion 34 is formed at an inner side location, in the vehicle width direction, and at a rear side with respect to the coilover fixing portion 30. The second fixing portion 34 is, similarly to the first fixing portion 32, offset to the lower side with respect to the coilover fixing portion 30. A cutout portion 36 is formed as a rectangular shaped cutout at a front-rear direction intermediate portion and at a vehicle width direction outer side location of each of the suspension towers 28. A location at the vehicle width direction inner side of the upper portion of each of the suspension towers 28 is a location corresponding to the coilover fixing portion 30, to a location at the front side (a location corresponding to the first fixing portion 32) and to a location at the rear side (a location corresponding to the second fixing portion 34) with respect to the coilover fixing portion 30.

The connection member 38 is provided at the vehicle front section 52 to connect a location at a vehicle width direction inner side of an upper portion of one of the suspension towers 28 to a location at a vehicle width direction inner side of an upper portion of the other suspension tower 28 by connecting in the vehicle width direction. Note that the connection member 38 is a member that is also sometimes called a tower bar.

The connection member 38 includes a main body 40 extending in the vehicle width direction between one suspension tower 28 and the other suspension tower 28. The connection member 38 includes a front connection portion 42 extending from a right end portion 40R of the main body 40 inclined toward the front side on progression toward the right side. Furthermore, the connection member 38 also includes a rear connection portion 44 that serves as an inclined connection portion extending from the right end portion 40R of the main body 40 so as to be inclined toward the rear side on progression toward the right side. The connection member 38 also includes a front connection portion 42 that extends from a left end portion 40L of the main body 40 so as to be inclined toward the front side on progression toward the left side. Furthermore, the connection member 38 also includes a rear connection portion 44 serving as an inclined connection portion that extends from the left end portion 40L of the main body 40 so as to be inclined toward the rear side on progression toward the left side.

In the connection member 38 of the present exemplary embodiment, the main body 40 is curved so as to be a convex shape toward the vehicle front side when viewed from above (in vehicle plan view). More specifically, the right rear connection portion 44, the main body 40, and the left rear connection portion 44 are formed as a single body using a round pipe-shaped member 40A. A location on the round pipe-shaped member 40A where the main body 40 is formed is curved so as to be a convex shape toward the vehicle front side. The location of the round pipe-shaped member 40A where the right rear connection portion 44 is formed extends in a straight line shape toward a right front pillar 26 side. Furthermore, the location of the round pipe shaped member 40A where the left rear connection portion 44 is formed extends in a straight line shape toward a left front pillar 26 side.

A leading end portion (vehicle width direction outer side end portion) of the right front connection portion 42 is fixed to the first fixing portion 32 formed at the right suspension tower 28 through a fastening member such as a bolt. Moreover, a leading end portion (vehicle width direction outer side end portion) of the right rear connection portion 44 is fixed to the second fixing portion 34 formed at the right suspension tower 28 through a non-illustrated fastening member. Moreover, a leading end portion (vehicle width direction outer side end portion) of the left front connection portion 42 is fixed to the first fixing portion 32 formed at the left suspension tower 28 through a non-illustrated fastening member. Moreover, a leading end portion (vehicle width direction outer side end portion) of the left rear connection portion 44 is fixed to the second fixing portion 34 formed at the left suspension tower 28 through a non-illustrated fastening member.

In a state in which the connection member 38 is fixed to the left-right pair of suspension towers 28, the right front pillar 26 is positioned on an extension of the right rear connection portion 44 and the left front pillar 26 is positioned on an extension of the left rear connection portion 44.

A brace 60 is provided to connect a location at the vehicle width direction inner side of the right suspension tower 28 to the right front pillar 26. A front end portion and vehicle width direction inner side end portion of the brace 60 is fixed to the second fixing portion 34 of the right suspension tower 28 by welding or the like. Moreover, a rear end portion and vehicle width direction outer side end portion of the brace 60 is disposed in a connected state to the right front pillar 26. Note that the rear end portion and vehicle width direction outer side end portion of the brace 60 may be fixed to the right front pillar 26 by welding or the like. Thereby, the right rear connection portion 44 of the connection member 38 and the right front pillar 26 are connected together through the brace 60. Note that a state connected by the brace 60 means a state in which the brace 60 is in a connected state to both members (the suspension tower 28 and the front pillar 26) and spans between the two members. The brace 60 is provided so as to be disposed along the direction of extension of the right rear connection portion 44.

### Operation and Effects of Present Exemplary Embodiment

Next, description follows regarding the operation and effects of the present exemplary embodiment.

As illustrated in FIG. 2, when a left side of the vehicle front section 52, which is applied with the vehicle front section structure of the present exemplary embodiment, is involved in an offset collision with a collision object 46, such as a small overlap head on collision or the like, a large part of a collision load F1 therefrom is transmitted to the right suspension tower 28 through the left front side member 14, the left suspension tower 28, and the left front connection portion 42, the main body 40, and the right rear connection portion 44 of the connection member 38. The load transmitted to the right suspension tower 28 is transmitted to the right front pillar 26 through the brace 60. In this configuration, the collision load F1 input to the left side of the vehicle front section 52 can be transmitted diagonally toward a right side of the vehicle front section 52 and toward a cabin 12 side (right front pillar 26 side). This thereby enables a larger reaction force F2 (reaction force F2 from the collision object 46) that displaces the vehicle toward the opposite side to the collision object 46 to be obtained than in a configuration not provided with the connection member 38 and the brace 60. The vehicle can be displaced toward the right side when the left side of the vehicle front section 52 is involved in an offset collision with the collision object 46, such as a small overlap head on collision or the like, enabling the collision object 46 to be suppressed from intruding into the cabin 12 side.

In the present exemplary embodiment, the main body 40 of the connection member 38 is curved so as to be a convex shape toward the vehicle front side as viewed from above. This means that when the above collision load F1 is transmitted to the main body 40, a force of axial compression (a force to compress the location of the round pipe-shaped member 40A where the main body 40 is formed in the axial direction thereof) is generated on the main body 40 in addition to a force attempting to bend the main body 40. The present exemplary embodiment accordingly enables deformation of the connection member 38 to be suppressed compared to a configuration in which a force to axially compress the main body 40 is not liable to be generated when the collision load F1 is transmitted to the main body 40 (for example, a configuration in which the main body 40 extends in a straight line along the vehicle width direction).

The brace 60 is provided so as to be disposed along a direction of extension of the right rear connection portion 44. In such a configuration the load transmitted to the right rear connection portion 44 can be transmitted to the brace 60 more effectively than configurations in which the brace 60 is provided along a direction different to the above direction.

Note that an example has been described in which the brace 60 is provided so as to connect a location on the vehicle width direction inner side of the right suspension tower 28 to the right front pillar 26, the present disclosure is not limited thereto. For example, for vehicles in countries where vehicles drive on the left, the right side of the vehicle front section 52 has a higher possibility of an offset collision with an oncoming vehicle as the collision object 46 than the left side thereof. In such cases, providing the brace 60 so as to connect a location on the vehicle width direction inner side of the left suspension tower 28 to the left front pillar 26 enables the vehicle to be displaced toward the left side when the right side of the vehicle front section 52 is involved in an offset collision with the collision object 46, such as a small overlap head on collision or the like. As a result thereof, the collision object 46 can be suppressed from intruding into the cabin 12 side. Moreover, a configuration may be adopted that is provided with both a brace 60 that connects a location at the vehicle width direction inner side of the right suspension tower 28 to the right front pillar 26, and also a brace 60 that connects a location at the vehicle width direction inner side of the left suspension tower 28 to the left front pillar 26.

Although an example has been described of a configuration in which the front connection portion 42 and the rear connection portion 44 are provided at both sides, in the vehicle width direction, of the connection member 38, the present disclosure is not limited thereto. For example, for vehicles in countries where vehicles drive on the right, the left side of the vehicle front section 52 has a higher possibility of an offset collision with an oncoming vehicle as the collision object 46 than the right side thereof. In such cases a configuration may be adopted in which the front connection portion 42 is provided only on the left side of the connection member 38, and the rear connection portion 44 is provided only on the right side of the connection member 38. Moreover, for vehicles in countries where vehicles drive on the left, the right side of the vehicle front section 52 has a higher possibility of an offset collision with an oncoming vehicle as the collision object 46 than the left side thereof. In such cases a configuration may be adopted in which the front connection portion 42 is provided only on the right side of the connection member 38, and the rear connection portion 44 is provided only on the left side of the connection member 38.

Although examples have been described in which the connection member 38 is provided connecting the left-right pair of suspension towers 28, the present disclosure is not limited thereto. For example, a configuration may be adopted in which the connection member 38 connects the left-right pair of front side members 14. Moreover, the configuration of the connection member 38 is not limited to the configuration described above. For example, a configuration may be adopted in which the connection member 38 is provided in a straight line extending along the vehicle width direction.

### Second Exemplary Embodiment

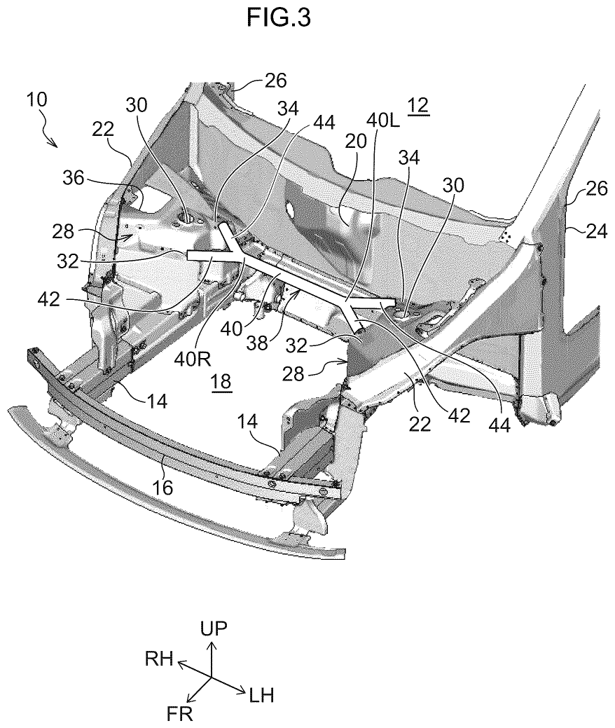

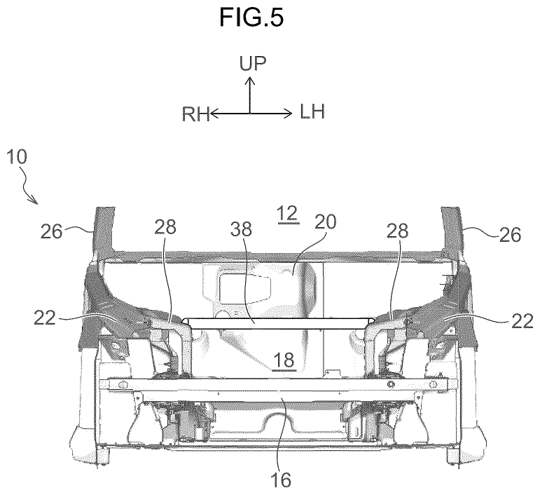

Description follows regarding a vehicle front section 10 applied with a vehicle front section structure according to a second exemplary embodiment of the present disclosure, with reference to FIG. 3 to FIG. 5. Note that in the vehicle front section 10 according to the second exemplary embodiment, the same reference numerals to those of the first exemplary embodiment will be appended to members and parts corresponding to those of the vehicle front section 52 according to the first exemplary embodiment, and explanation thereof will be omitted.

As illustrated in FIG. 3 to FIG. 5, in the vehicle front section 10 a left-right pair of front side members 14 extending along the front-rear direction are disposed spaced apart from each other in the vehicle width direction at a front side of a cabin 12. A bumper reinforcement 16 is fixed to a front end portion of each of the front side members 14.

In the vehicle front section 10 a left-right pair of apron upper members 22 is provided at an upper side and vehicle width direction outer side with respect to the front side members 14. Rear end portions of the apron upper members 22 are respectively joined to a left-right pair of front pillars 26. Note that each of the front pillars 26 is configured including a front pillar upper member disposed at an upper side with respect to the apron upper members 22, and a front pillar lower member disposed further to the lower side than the front pillar upper member.

A left-right pair of suspension towers 28 is provided at the vehicle front section 10. Lower end portions of the suspension towers 28 are respectively joined to the front side members 14. Furthermore, upper end portions and vehicle width direction outer side end portions of the suspension towers 28 are respectively joined to the apron upper members 22. Note that parts corresponding to the front side members such as the left-right pair of front side members 14, the left-right pair of suspension towers 28, the left-right pair of apron upper members 22, and the like may be configured by being formed as a single body by casting or the like. Reference to casting also encompasses manufacturing by die casting or the like.

A coilover fixing portion 30 to which an upper end portion of a non-illustrated coilover is fixed is provided at an intermediate portion, in the front-rear direction, and at an inner side location, in the vehicle width direction, of an upper portion of each of the suspension towers 28. A first fixing portion 32 is formed at a front side with respect to the coilover fixing portion 30. The first fixing portion 32 is offset to a lower side with respect to the coilover fixing portion 30. A second fixing portion 34 is also formed at a rear side with respect to the coilover fixing portion 30. The second fixing portion 34 is, similarly to the first fixing portion 32, also offset to the lower side with respect to the coilover fixing portion 30. Note that a cutout portion 36 is formed as a rectangular shaped cutout at a front-rear direction intermediate portion and at the vehicle width direction outer side location of each of the suspension towers 28.

A connection member 38 is provided at the vehicle front section 10 to connect a vehicle width direction inner side location of an upper portion of one of the suspension towers 28 to a vehicle width direction inner side location of an upper portion of the other suspension tower 28 by connecting in the vehicle width direction. Note that the connection member 38 is a member that is also sometimes called a tower bar.

The connection member 38 includes a main body 40 that extends in the vehicle width direction between one suspension tower 28 and the other suspension tower 28. The connection member 38 also includes a front connection portion 42 that extends from a right end portion 40R of the main body 40 so as to be inclined toward the front side on progression toward the right side. Furthermore, the connection member 38 also includes a rear connection portion 44 that extends from the right end portion 40R of the main body 40 so as to be inclined toward the rear side on progression toward the right side. The connection member 38 also includes a front connection portion 42 that extends from a left end portion 40L of the main body 40 so as to be inclined toward the front side on progression toward the left side. Furthermore, the connection member 38 also includes a rear connection portion 44 that extends from the left end portion 40L of the main body 40 so as to be inclined toward the rear side on progression toward the left side. Note that the angle of inclination toward the front side with respect to the vehicle width direction of the right front connection portion 42 and the angle of inclination toward the rear side with respect to the vehicle width direction of the right rear connection portion 44 are the same. Moreover, the angle of inclination toward the front side with respect to the vehicle width direction of the left front connection portion 42 and the angle of inclination toward the rear side with respect to the vehicle width direction of the left rear connection portion 44 are the same.

A leading end portion (vehicle width direction outer side end portion) of the right front connection portion 42 is fixed to the first fixing portion 32 formed at the right suspension tower 28 through a non-illustrated fastening member. A leading end portion (vehicle width direction outer side end portion) of the right rear connection portion 44 is fixed to the second fixing portion 34 formed at the right suspension tower 28 through a non-illustrated fastening member. A leading end portion (vehicle width direction outer side end portion) of the left front connection portion 42 is fixed to the first fixing portion 32 formed at the left suspension tower 28 through a non-illustrated fastening member. A leading end portion (vehicle width direction outer side end portion) of the left rear connection portion 44 is fixed to the second fixing portion 34 formed at the left suspension tower 28 through a non-illustrated fastening member.

In a state in which the connection member 38 is fixed to the left-right pair of suspension towers 28, the right front pillar 26 is positioned on an extension of the right rear connection portion 44 and the left front pillar 26 is positioned on an extension of the left rear connection portion 44.

### Operation and Effects of Present Exemplary Embodiment

Next, description follows regarding the operation and effects of the present exemplary embodiment.

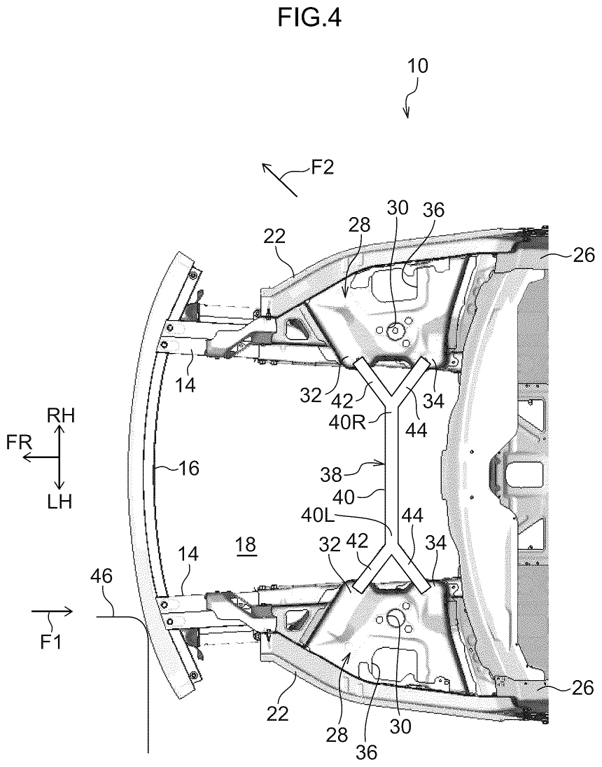

As illustrated in FIG. 4, when the left side of the vehicle front section 10, which is applied with the vehicle front section structure of the present exemplary embodiment, is involved in an offset collision with a collision object 46, such as a small overlap head on collision or the like, a large part of a collision load F1 therefrom is transmitted from the left side of the vehicle front section 10 to the right side thereof through the left front side member 14, the left suspension tower 28, and the left front connection portion 42, the main body 40, and the right rear connection portion 44 of the connection member 38.

The left front connection portion 42 extends from the left end portion 40L of the main body 40 inclined toward the front side on progression toward the left side. In addition thereto, the right rear connection portion 44 extends from the right end portion 40R of the main body 40 inclined toward the rear side on progression toward the right side. In this configuration the collision load F1 input to the left side of the vehicle front section 10 can be transmitted at an angle toward the right side of the vehicle front section 10 and toward the cabin 12 side (right front pillar 26 side). This thereby enables a larger reaction force F2 (reaction force F2 from the collision object 46) that displaces the vehicle toward the opposite side to the collision object 46 to be obtained than in configurations in which the left front connection portion 42 and the right rear connection portion 44 are configured not extending in the directions described above. Namely, reaction force is imparted to the vehicle front section 10 in a diagonally rearward direction. As a result thereof, when the left side of the vehicle front section 10 is involved in an offset collision with the collision object 46, such as a small overlap head on collision or the like, the vehicle can be effectively displaced toward the right side, enabling intrusion of the collision object 46 into the cabin 12 side to be suppressed.

Note that the vehicle can be displaced toward the left side when the right side of the vehicle front section 10, which is applied with the vehicle front section structure of the present exemplary embodiment, is involved in an offset collision with the collision object 46, such as a small overlap head on collision or the like. This thereby enables intrusion of the collision object 46 into the cabin 12 side to be suppressed.

In the present exemplary embodiment, the front connection portion 42 and the rear connection portion 44 are configured so as to be provided at both sides, in the vehicle width direction, of the connection member 38. The left front connection portion 42 and the left rear connection portion 44 are respectively fixed to the first fixing portion 32 and the second fixing portion 34 of the left suspension tower 28. The right front connection portion 42 and the right rear connection portion 44 are respectively fixed to the first fixing portion 32 and the second fixing portion 34 of the right suspension tower 28. In this configuration the left suspension tower 28 (and in particular in the vicinity of the coilover fixing portion 30) can be reinforced by the left front connection portion 42 and the left rear connection portion 44, and also the right suspension tower 28 (and in particular in the vicinity of the coilover fixing portion 30) can be reinforced by the right front connection portion 42 and the right rear connection portion 44. This thereby enables deformation of each of the suspension towers 28 during an offset collision to be suppressed. In particular, rotational deformation (buckling deformation so as to rotate when viewed from above) of each of the suspension towers 28 during an offset collision can be suppressed compared to configurations not provided with the front connection portion 42 and the rear connection portion 44 at both sides, in the vehicle width direction, of the connection member 38 (configurations in which both vehicle width direction ends of a connection member are fastened and fixed to single respective locations on a left-right pair of suspension towers 28). As a result thereof, the collision load F1 input to a vehicle width direction first side of the vehicle front section 10 can be more reliably transmitted to a vehicle width direction second side of the vehicle front section 10.

### Third Exemplary Embodiment

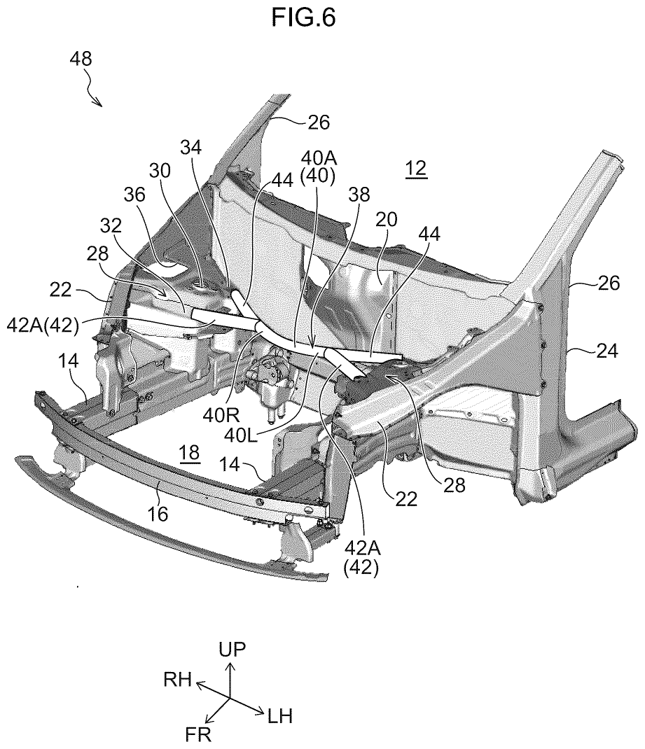

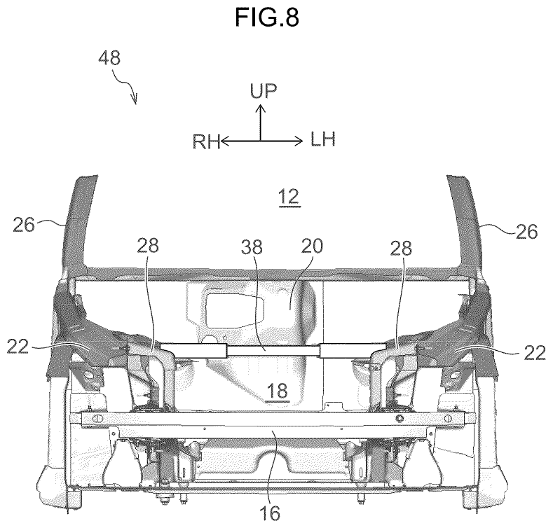

Description follows regarding a vehicle front section 48 applied with a vehicle front section structure according to a third exemplary embodiment of the present disclosure, with reference to FIG. 6 to FIG. 8. Note that in the vehicle front section 48 according to the third second exemplary embodiment, the same reference numerals to members and parts corresponding to the vehicle front section 10 will be appended to members and parts corresponding to those of the vehicle front section 10 according to the second exemplary embodiment, and explanation thereof will be omitted.

As illustrated in FIG. 6 to FIG. 8, the configuration of the vehicle front section 48 of the present exemplary embodiment is a configuration similar to that of the vehicle front section 10 of the second exemplary embodiment, except in having a different configuration of connection member 38.

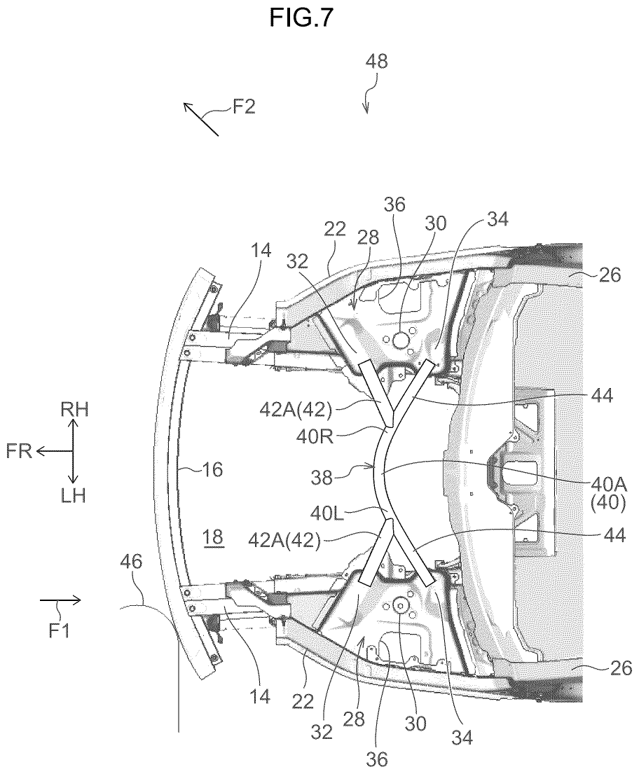

As illustrated in FIG. 6 and FIG. 7, in the connection member 38 of the present exemplary embodiment, the main body 40 is curved so as to be a convex shape toward the vehicle front side when viewed from above (in vehicle plan view). More specifically, a right rear connection portion 44, a main body 40, and a left rear connection portion 44 are formed as a single body using a round pipe-shaped member 40A. A location at the round pipe-shaped member 40A where the main body 40 is formed is curved so as to be a convex shape toward the vehicle front side. The location at the round pipe shaped member 40A where the right rear connection portion 44 is formed extends in a straight line shape toward the right front pillar 26 side. Furthermore, the location at the round pipe-shaped member 40A where the left rear connection portion 44 is formed extends in a straight line shape toward the left front pillar 26 side. Namely, the rear connection portion 44 is provided at an extension of a vehicle width direction outer side end portion of the main body 40.

A member 42A forming the right front connection portion 42 is a separate member to the round pipe-shaped member 40A. The member 42A forming the right front connection portion 42 is joined to the round pipe-shaped member 40A by welding or the like. A member 42A forming the left front connection portion 42 is a separate member to the round pipe shaped member 40A. The member 42A forming the left front connection portion 42 is joined to the round pipe shaped member 40A by welding or the like.

When the left side of the vehicle front section 48, which is applied with the vehicle front section structure of the present exemplary embodiment, is involved in an offset collision with a collision object 46, such as a small overlap head on collision or the like, a large part of a collision load F1 therefrom is transmitted from the left side of the vehicle front section 10 to the right side thereof through the left front side member 14, the left suspension tower 28, the left front connection portion 42, the main body 40, and the right rear connection portion 44.

The main body 40 is curved so as to be a convex shape toward the vehicle front side as viewed from above. This means that when the above collision load F1 is transmitted to the main body 40, a force of axial compression (a force to compress the location of the round pipe-shaped member 40A where the main body 40 is formed in the axial direction thereof) is generated on the main body 40 in addition to a force attempting to bend the main body 40. The present exemplary embodiment accordingly enables deformation of the connection member 38 to be suppressed compared to a configuration in which a force to axially compress the main body 40 is not liable to be generated when the above collision load F1 is transmitted to the main body 40 (for example, a configuration in which the main body 40 extends in a straight line along the vehicle width direction).

The rear connection portions 44 are each provided on an extension of the vehicle width direction outer side end portion of the main body 40. In this configuration, load transmitted to the main body 40 can be transmitted more effectively to the rear connection portion 44 than in configurations in which the rear connection portion 44 is not provided on an extension of the vehicle width direction outer side end portion of the main body 40.

### Fourth Exemplary Embodiment

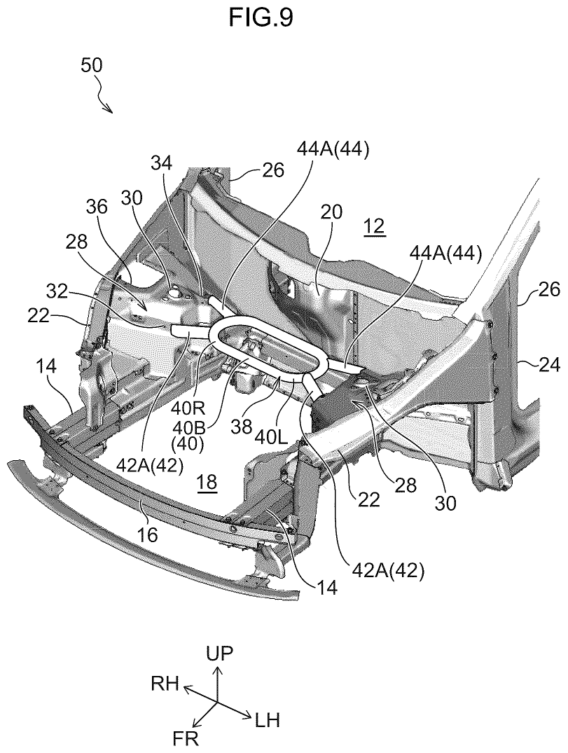

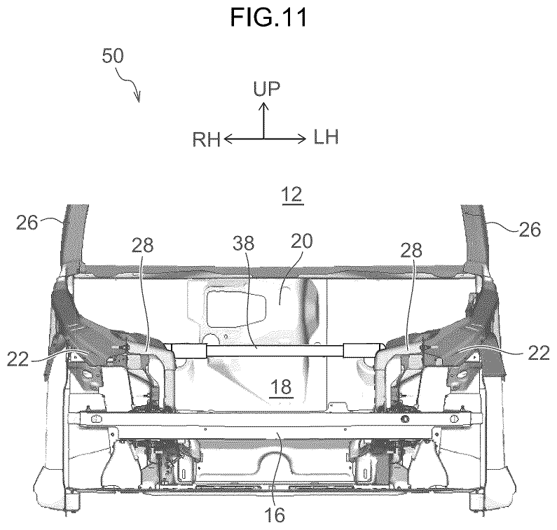

Description follows regarding a vehicle front section 50 applied with a vehicle front section structure according to a fourth exemplary embodiment of the present disclosure, with reference to FIG. 9 to FIG. 11. Note that in the vehicle front section 50 according to a fourth exemplary embodiment, the same reference numerals to members and parts corresponding to the vehicle front section 10 will be appended to members and parts corresponding to the vehicle front section 10 according to the second exemplary embodiment, and explanation thereof will be omitted.

As illustrated in FIG. 9 to FIG. 11, the configuration of the vehicle front section 50 of the present exemplary embodiment is a configuration similar to that of the vehicle front section 10 of the second exemplary embodiment, except for a different configuration of connection members 38.

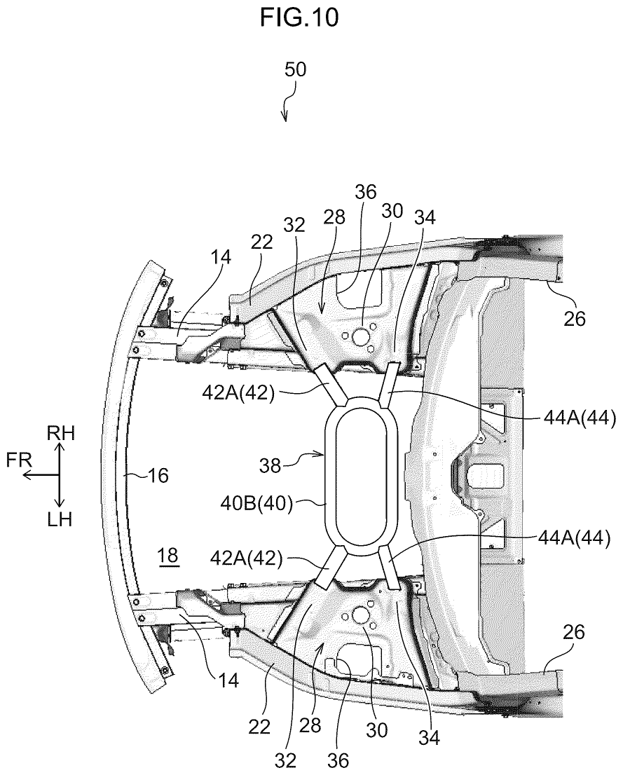

As illustrated in FIG. 9 and FIG. 10, in the connection member 38 of the present exemplary embodiment, the main body 40 is formed in a closed ring shape in vehicle plan view. More specifically, the main body 40 is formed in an elliptical shape (oval shape) having a long axis along the left-right direction in vehicle plan view.

A member 42A forming a right front connection portion 42 is a separate member to a member 40B forming a main body 40. The member 42A forming the right front connection portion 42 is joined to a location on the front side of a right end portion 40R of the main body 40 by welding or the like. Moreover, a member 42A forming the left front connection portion 42 is a separate member to a member 40B. The member 42A forming the left front connection portion 42 is joined to a location on the front side of a left end portion 40L of the main body 40 by welding or the like. Moreover, a member 44A forming the right rear connection portion 44 is a separate member to the member 40B. The member 44A forming the right rear connection portion 44 is joined to a location on the rear side of the right end portion 40R of the main body 40 by welding or the like. The member 44A forming the left rear connection portion 44 is a separate member to the member 40B. The member 44A forming the left rear connection portion 44 is joined to a location at a rear side of the left end portion 40L of the main body 40 by welding or the like.

The main body 40 is formed in a closed ring shape in vehicle plan view. Such a configuration is able to transmit a larger load from a vehicle width direction first side of the vehicle front section 50 to a vehicle width direction second side thereof than in configurations in which the main body 40 is not configured in a closed ring shape.

Note that although in the vehicle front section 50 of the present exemplary embodiment an example has been described in which the main body 40 is formed in a closed ring shape, the present disclosure is not limited thereto. For example, the main body 40 may be configured in a closed polygonal shape.

Although each of the exemplary embodiments described above have been described for examples in which the front connection portions 42 and the rear connection portions 44 are configured so as to be provided at both sides, in the vehicle width direction, of the connection member 38, the present disclosure is not limited thereto. For example, for vehicles in countries where vehicles drive on the right, the left side of the vehicle front section 10, 48, 50 has a higher possibility of an offset collision with an oncoming vehicle as the collision object 46 than the right side thereof. In such cases a configuration may be adopted in which the front connection portion 42 is provided only on the left side of the connection member 38, and the rear connection portion 44 is provided only on the right side of the connection member 38. Moreover, for vehicles in countries where vehicles drive on the left, the right side of the vehicle front section 10, 48, 50 has a higher possibility of an offset collision with an oncoming vehicle as the collision object 46 than the left side thereof. In such cases a configuration may be adopted in which the front connection portion 42 is provided only on the right side of the connection member 38, and the rear connection portion 44 is provided only on the left side of the connection member 38.

Although in each of the exemplary embodiment described above explanation has been given of examples in which the front connection portions 42 and the rear connection portions 44 are joined and fixed to the suspension tower 28, the present disclosure is not limited thereto. For example, a configuration may be adopted in which the front connection portions 42 and the rear connection portions 44 are configured joined and fixed to the front side members 14.

Although the present disclosure has been described above by way of exemplary embodiments, the present disclosure is not limited thereby, and obviously various other modifications may be implemented not departing from the scope of the present disclosure.

### SUPPLEMENTS

### Supplement 1

A vehicle front section structure including:
a left-right pair of front pillars, the front pillars respectively forming parts of front door openings that are respectively formed at a left side and a right side in a vehicle width direction;
a left-right pair of front side members extending along a vehicle front-rear direction and disposed spaced apart from each other in the vehicle width direction at a vehicle front side with respect to the left-right pair of front pillars;
a left-right pair of suspension towers respectively formed with profiles that project toward an upper side with respect to the left-right pair of front side members;
a connection member connecting the left-right pair of suspension towers or connecting the left-right pair of front side members, the connection member including a main body extending in the vehicle width direction, and an inclined connection portion that extends toward a rear side and toward a vehicle width direction outer side from at least one end portion of a first side end portion or a second side end portion, in the vehicle width direction of the main body; and
a brace connecting the inclined connection portion to the front pillar on the inclined connection portion side.

### Supplement 2

A vehicle front section structure including:
a left-right pair of front pillars, the front pillars respectively forming parts of front door openings that are respectively formed at a left side and a right side in a vehicle width direction;
a left-right pair of front side members extending along a vehicle front-rear direction and disposed spaced apart from each other in the vehicle width direction at a vehicle front side with respect to the left-right pair of front pillars;
a left-right pair of suspension towers respectively formed with profiles that project toward an upper side with respect to the left-right pair of front side members;
a connection member extending in the vehicle width direction and connecting the left-right pair of suspension towers or connecting the left-right pair of front side members; and
at least one brace of a brace that connects an inner side location, in the vehicle width direction, of a suspension tower on a first side to a front pillar on the vehicle width direction first side, or a brace that connects an inner side location, in the vehicle width direction, of a suspension tower on a second side in the vehicle width direction to a front pillar on the second side in the vehicle width direction.

### Supplement 3

The vehicle front section structure of Supplement 1, wherein the brace is provided so as to be disposed along a direction of extension of the inclined connection portion.

### Supplement 4

The vehicle front section structure of Supplement 1 of Supplement 3, wherein the main body is curved so as to be a convex shape toward the vehicle front side in vehicle plan view.

### Supplement 5

The vehicle front section structure of any one of Supplements 1, Supplement 3, or Supplement 4, wherein:
the connection member includes a front connection portion that extends from an end portion on a side of the main body where the inclined connection portion is provided toward a vehicle front side and toward a vehicle width direction outer side; and the front connection portion and the inclined connection portion are fixed to the suspension tower.

### Supplement 6

The vehicle front section structure of Supplement 5, wherein:
a coilover fixing portion to which a coilover is to be fixed is provided at the suspension tower;
the front connection portion is fixed to a location on the suspension tower further toward the vehicle front side than the coilover fixing portion; and
the inclined connection portion is fixed to a location on the suspension tower further toward a vehicle rear side than the coilover fixing portion.

### Supplement 7

The vehicle front section structure of any one of Supplement 1 to Supplement 6, wherein the left-right pair of front side members and the left-right pair of suspension towers are formed as a single body.

What is claimed is:

1. A vehicle front section structure comprising:
a left-right pair of front pillars, the front pillars respectively forming parts of front door openings that are respectively formed at a left side and a right side in a vehicle width direction;
a left-right pair of front side members extending along a vehicle front-rear direction and disposed spaced apart from each other in the vehicle width direction at a vehicle front side with respect to the left-right pair of front pillars;
a left-right pair of suspension towers respectively formed with profiles that project toward an upper side with respect to the left-right pair of front side members;
a connection member connecting the left-right pair of suspension towers or connecting the left-right pair of front side members, the connection member including a main body extending in the vehicle width direction, and an inclined connection portion that extends toward a rear side and toward a vehicle width direction outer side from at least one end portion of a first side end portion or a second side end portion, in the vehicle width direction, of the main body; and
a brace connecting the inclined connection portion to a front pillar on an inclined connection portion side.

2. A vehicle front section structure comprising:
a left-right pair of front pillars, the front pillars respectively forming parts of front door openings that are respectively formed at a left side and a right side in a vehicle width direction;
a left-right pair of front side members extending along a vehicle front-rear direction and disposed spaced apart from each other in the vehicle width direction at a vehicle front side with respect to the left-right pair of front pillars;
a left-right pair of suspension towers respectively formed with profiles that project toward an upper side with respect to the left-right pair of front side members;
a connection member extending in the vehicle width direction and connecting the left-right pair of suspension towers or connecting the left-right pair of front side members; and
at least one brace of a brace that connects an inner side location, in the vehicle width direction, of a suspension tower on a first side in the vehicle width direction to a front pillar on the first side in the vehicle width direction, or a brace that connects an inner side location, in the vehicle width direction, of a suspension tower on a second side in the vehicle width direction to a front pillar on the second side in the vehicle width direction.

3. The vehicle front section structure of claim 1, wherein the brace is provided so as to be disposed along a direction of extension of the inclined connection portion.

4. The vehicle front section structure of claim 1, wherein the main body is curved so as to be a convex shape toward a vehicle front side in vehicle plan view.

5. The vehicle front section structure of claim 1, wherein:
the connection member includes a front connection portion that extends from an end portion on a side of the main body where the inclined connection portion is provided toward a vehicle front side and toward a vehicle width direction outer side; and
the front connection portion and the inclined connection portion are fixed to the suspension tower.

6. The vehicle front section structure of claim 5, wherein:
a coilover fixing portion, to which a coilover is to be fixed, is provided at the suspension tower;
the front connection portion is fixed to a location on the suspension tower further toward the vehicle front side than the coilover fixing portion; and
the inclined connection portion is fixed to a location on the suspension tower further toward a vehicle rear side than the coilover fixing portion.

7. The vehicle front section structure of claim 1, wherein the left-right pair of front side members and the left-right pair of suspension towers are formed as a single body.

8. The vehicle front section structure of claim 3, wherein the left-right pair of front side members and the left-right pair of suspension towers are formed as a single body.
